(19) United States
(12) Patent Application Publication
(10) Pub. No.: US 2024/0370498 A1
(43) Pub. Date: Nov. 7, 2024

(54) AUTOMATIC TEXTUAL DOCUMENT EVALUATION USING LARGE LANGUAGE MODELS

(71) Applicant: NEC Corporation Of America, Herzlia (IL)

(72) Inventors: Tsvi LEV, Tel-Aviv (IL); Or KATZ, Ganei Tikva (IL); Maya COHEN MAIMON, Holon (IL)

(73) Assignee: NEC Corporation Of America, Herzlia (IL)

(21) Appl. No.: 18/142,643

(22) Filed: May 3, 2023

(51) Int. Cl. G06F 16/9032; G06F 40/20

(52) U.S. Cl. CPC G06F 16/90332; G06F 40/20

(57) ABSTRACT

A system and a method for analyzing conversation text using a flow of query prompts, an ensemble of close ended questions and a neural network based language model. The method may be used as a tutor or examination bot, for mental coherency screening, data mining, clustering groups of trainees or customers according to training needs or interests, and the likes.

### FIELD AND BACKGROUND OF THE INVENTION

The present invention, in some embodiments thereof, relates to text classification, and, more particularly, but not exclusively, usage of generative conversational language to evaluate text.

Training and education, particularly in humanistic, but also in nature and exact science, may involve instructing a large number of trainees to generate text that has to be evaluated, such as assignments and exam questions.

Evaluating the text by a tutor may be a repetitive, time consuming job, and often done in a rudimentary, biased or haphazard manner. Keyword search may be applied, however, is limited and automatic interpretation may misinterpret valence of sentences.

Similar challenge is present in customer service, data mining, evaluation of marketing leads, and the like. Furthermore, customizing a product or a service such as vacation, or news report, may also involve a similar task for extracting customers' requirement preferences.

### SUMMARY OF THE INVENTION

It is an object of the present invention to provide a system and a method for evaluating a textual content by applying queries based thereupon on a decision model using an ensemble of close ended questions and a model comprising conversational language model.

According to an aspect of some embodiments of the present invention there is provided a method for evaluating understanding in a textual content, comprising:
receiving a textual content generated by group of users in response to an assignment;
processing the textual content to generate a plurality of queries;
generating a plurality of inference values pertaining to the users, each by feeding one of the plurality of close ended queries to at least one conversational language model;
processing the plurality of inference to generate at least one evaluation of the textual content; and
using the at least one evaluation to generate at least one second prompt.

According to an aspect of some embodiments of the present invention there is provided a system comprising a storage and at least one processing circuitry configured to:
receive a textual content generated by group of users in response to an assignment;
process the textual content to generate a plurality of queries;
generate a plurality of inference values pertaining to the users, each by feeding one of the plurality of close ended queries to at least one conversational language model;
process the plurality of inference to generate at least one evaluation of the textual content; and
use the at least one evaluation to generate at least one second prompt.

According to an aspect of some embodiments of the present invention there is provided one or more computer program products comprising instructions for evaluating understanding in a textual content, wherein execution of the instructions by one or more processors of a computing system is to cause a computing system to:
receiving a textual content generated by group of users in response to an assignment;
processing the textual content to generate a plurality of queries;
generating a plurality of inference values pertaining to the users, each by feeding one of the plurality of close ended queries to at least one conversational language model;
processing the plurality of inference to generate at least one evaluation of the textual content; and
using the at least one evaluation to generate at least one second prompt.

Optionally, using the at least one second prompt for querying the group of users for an additional textual content.

Optionally, the at least one evaluation is based on relevance of the additional textual content to the at least one second prompt.

Optionally, the at least one second prompt comprising a suggestion derived from the at least one evaluation.

Optionally, the at least one evaluation is based on checking when a specified suggestion is present in the textual content.

Optionally, the at least one evaluation is counting how many users in the group of users included the specified suggestion in the textual content pertaining thereto

Optionally, the suggestion is associated with an item pertaining to the assignment.

Optionally, the at least one evaluation is based on evaluating a coherence measure of the textual content.

Optionally, the evaluation comprising detection of suggestions not expected in response to the querying.

Optionally, using the evaluation to partition a group of students according to a similarity measure.

Optionally, processing the textual content comprising:
accessing a storage to obtain a plurality of close ended questions; and
generating a plurality of queries each from a combination of at least one part of the textual content pertaining to users from the group and one of the plurality of close ended questions.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for evaluating a textual content, according to some embodiments of the present disclosure;

FIG. 2 is a schematic diagram of a simplified exemplary system for evaluating a textual content classification module, according to some embodiments of the present disclosure;

FIG. 3 is a flowchart of an exemplary process for evaluating a textual content classification, according to some embodiments of the present disclosure;

FIG. 4 is an exemplary query on an exemplary textual content, according to some embodiments of the present disclosure;

FIG. 5 is an exemplary query on another exemplary textual content, according to some embodiments of the present disclosure;

FIG. 6 is another query on another exemplary textual content, according to some embodiments of the present disclosure; and

FIG. 7 is another exemplary query on yet another exemplary textual content, according to some embodiments of the present disclosure.

### DESCRIPTION OF SPECIFIC EMBODIMENTS OF THE INVENTION

The present invention, in some embodiments thereof, relates to text classification, and, more particularly, but not exclusively, usage of generative conversational language to evaluate text.

Some embodiments of the present invention process some parts of the textual content using a large language model (LLM) with queries prepared using an ensemble of close ended questions on parts of the textual content, and use the answers to evaluate whether the text meets certain criteria. A criteria may be when specified suggestions are present in the text, whether it is correct, coherent, relevance to specified issues, and/or the like.

Some embodiments of the present invention feed a language model with queries prepared using an ensemble of close ended questions on a text extracted from a document, a clip, a recording, and/or the like to be classified, and process inferences from the language model to classify the text.

Some embodiment of the present invention may wrap the text with queries prepared for an evaluation, and apply a pre-trained conversational language mode, which may be transformer neural network based, in the wrapped text. The queries may be close ended, i.e. Yes/No or other multiple choice question, rather than open ended questions. Some examples for close ended questions used in query preparation may be “did the student ask this already before?”, “Is the customer angry?”, “Does the student response contain terms related to lack of understanding or requests to repeat or rephrase the last interaction?”, and “Does the writer ridicule the subject in the following text?”. Some other examples include a query wrapper such as “Does the text . . . mention the term polymer” wherein ‘ . . . ’ include textual content pertaining to a student in a group. The latter query wrapper may be used to find out ted how many students from the group asked many questions about a specific term appearing in the text of the knowledge system. A similar wrapper may be used to find how many customers asked about, or referred to a specific proposed deal, for example, a promo on Bluetooth earphones for those joining a new cellular plan.

Some embodiments of the present invention enable automating one of the more routine tasks of tutors, in a predictive quality, where biases can be detected using a variety of artificial intelligence explainability schemes, and enabling balancing with privacy. The present invention may also be used for computer based tutorials in academy, industry, and other organizations, as well as personalized tutoring for people with verbal difficulties and other communication needs.

Some embodiments of the present invention may be also used to find unexpected frequently mentioned subjects both for a single customer or a group and propose clustering based thereupon.

Some embodiments of the present invention may also be used to help an instructor find when a training goal was obtained, where the students lack assumed background knowledge, or screen for incoherence which may be caused by a cognitive impairment, a mental health or emotional condition, influence of substance, or merely not taking the class seriously.

Some embodiments of the present invention may be used by a bot for private tutoring, or conduct interviews, examinations, and the likes using guiding questions.

Some embodiments of the present invention may provide accuracy improvement using different formulation for questions, and provide high accuracy based on weaker assumptions on the language model strength.

Some embodiments of the present invention may apply pre-processing such as translation and filter text for known weaknesses of the translation and/or the conversational language model. The conversational language model may be a large language model trained for various purposes which may not necessarily comprise text classification.

Some embodiment of the present invention extract closed ended inferences from a text generated by the model, and apply a preset function or an additional machine learning model to produce evaluation of the text.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

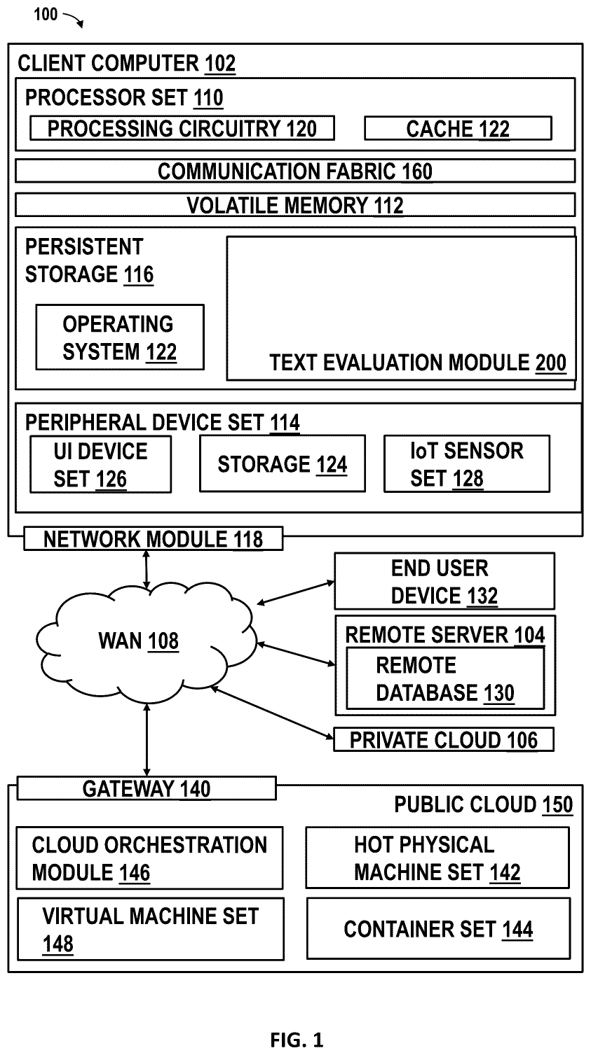

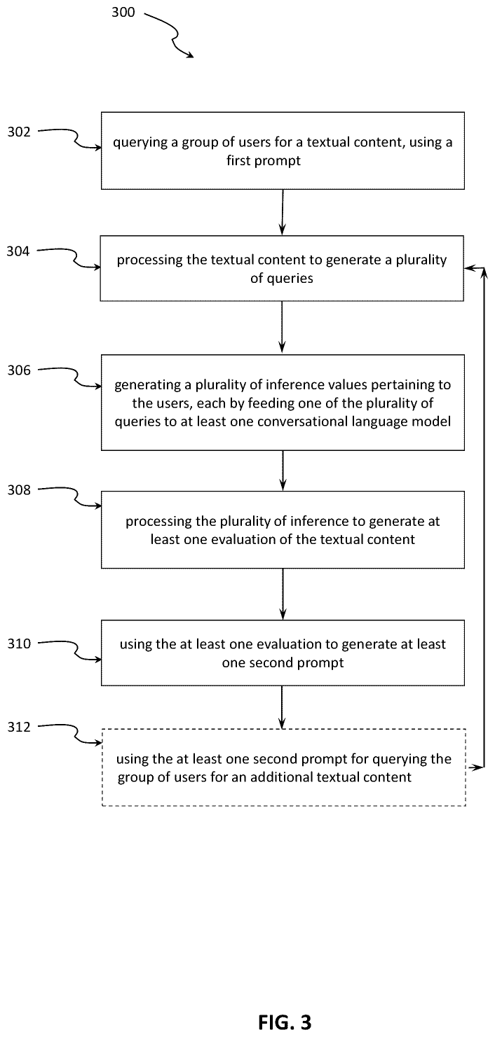

Referring now to the drawings, FIG. 1 is a schematic illustration of an exemplary system for evaluating a textual content, according to some embodiments of the present disclosure. An exemplary client computer system 100 may be used for executing execute processes such as 300 for text classification. Further details about these exemplary processes follow as FIG. 3 are described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a text evaluation module 200. In addition to block 200, computing environment 100 includes, for example, computer 102, wide area network (WAN) 108, end user device (EUD) 132, remote server 104, public cloud 150, and private cloud 106. In this embodiment, computer 102 includes processor set 110 (including processing circuitry 120 and cache 134), communication fabric 160, volatile memory 112, persistent storage 116 (including operating system 122 and block 200, as identified above), peripheral device set 114 (including user interface (UI), device set 126, storage 124, and Internet of Things (IoT) sensor set 128), and network module 118. Remote server 104 includes remote database 130. Public cloud 150 includes gateway 140, cloud orchestration module 146, host physical machine set 142, virtual machine set 148, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. For example, a processor set may include one or more of a central processing unit (CPU), a microcontroller, a parallel processor, supporting multiple data such as a digital signal processing (DSP) unit, a graphical processing unit (GPU) module, and the like, as well as optical processors, quantum processors, and processing units based on technologies that may be developed in the future. Processing circuitry 120 may be distributed over multiple packages, for example, multiple, coordinated integrated circuit chips. Processing circuitry 120 may implement multiple processor threads and/or multiple processor cores. Cache 134 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 134 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 116.

COMMUNICATION FABRIC 160 is the signal conduction paths that allow the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 116 is any form of non-volatile storage for computers that is now known or to be developed in the future. The non-volatility of this storage means that the stored data is maintained regardless of whether power is being supplied to computer 102 and/or directly to persistent storage 116. Persistent storage 116 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 126 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 128 is made up of sensors that can be used in Internet of Things applications. For example, one sensor may be a thermometer and another sensor may be a motion detector.

NETWORK MODULE 118 is the collection of computer software, hardware, and firmware that allows computer 102 to communicate with other computers through WAN 108. Network module 118 may include hardware, such as modems or Wi-Fi signal transceivers, software for packetizing and/or de-packetizing data for communication network k transmission, and/or web browser software for communicating data over the internet. In some embodiments, network control functions and network forwarding functions of network module 118 are performed on the same physical hardware device. In other embodiments (for example, embodiments that utilize software-defined networking (SDN)), the control functions and the forwarding functions of network module 118 are performed on physically separate devices, such that the control functions manage several different network hardware devices. Computer readable program instructions for performing the inventive methods can typically be downloaded to computer 102 from an external computer or external storage device through a network adapter card or network interface included in network module 118.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 132 is any computer system that is used and controlled by an end user (for example, a customer of an enterprise that operates computer 102), and may take any of the forms discussed above in connection with computer 102. EUD 132 typically receives helpful and useful data from the operations of computer 102. For example, in a hypothetical case where computer 102 is designed to provide a recommendation to an end user, this recommendation would typically be communicated from network module 118 of computer 102 through WAN 108 to EUD 132. In this way, EUD 132 can display, or otherwise present, the recommendation to an end user. In some embodiments, EUD 132 may be a client device, such as thin client, heavy client, mainframe computer, desktop computer and so on.

REMOTE SERVER 104 is any computer system that serves at least some data and/or functionality to computer 102. Remote server 104 may be controlled and used by the same entity that operates computer 102. Remote server 104 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 104.

PUBLIC CLOUD 150 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 150 is performed by the computer hardware and/or software of cloud orchestration module 146. The computing resources provided by public cloud 150 are typically implemented by virtual computing environments that run on various computers making up the computers of host physical machine set 142, which is the universe of physical computers in and/or available to public cloud 150. The virtual computing environments (VCEs) typically take the form of virtual machines from virtual machine set 148 and/or containers from container set 144. It is understood that these VCEs may be stored as images and may be transferred among and between the various physical machine hosts, either as images or after instantiation of the VCE. Cloud orchestration module 146 manages the transfer and storage of images, deploys new instantiations of VCEs and manages active instantiations of VCE deployments. Gateway 140 is the collection of computer software, hardware, and firmware that allows public cloud 150 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 150, except that the computing resources are only available for use by a single enterprise. While private cloud 106 is depicted as being in communication with WAN 108, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 150 and private cloud 106 are both part of a larger hybrid cloud.

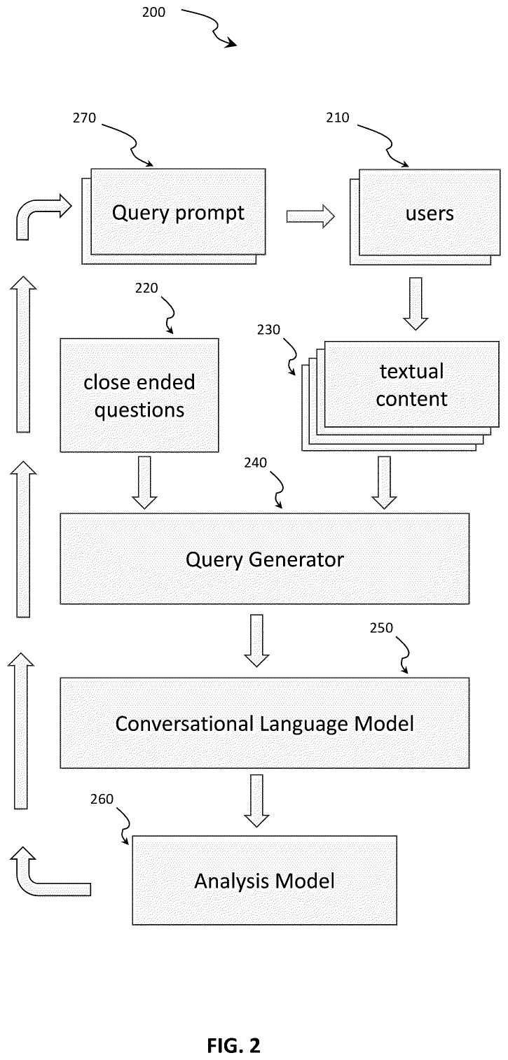

Referring now to FIG. 2, which is a schematic diagram of a simplified exemplary system for evaluating a textual content classification module, according to some embodiments of the present disclosure.

The diagram describes the primary essential and an optional architectural component of the text evaluation module 200.

The users 210 may be students in academy, employees receiving training or qualifying for a certification, leads found in an internet forum, potential customers filling a form or interacting with a chat-bot, and/or the likes. The system may process textual content pertaining to a group of users, which may refer to a single user, a class, a physical community, a virtual community, a group of employees, an entire customer pool, a part of a customer pool determined by a specified characteristic or by a more complex clustering scheme, and/or the like.

The close ended questions 220 may be based on one or more questions to verify a text contains a certain suggestion. The plurality of close ended questions may be based on one or more features of a proposed product, concepts introduced in a tutorial, general knowledge items, questionnaires, key point lists, and/or the like.

In some implementations, the plurality of close ended questions comprises one or more ensembles of close ended questions which relate to a similar subject.

In some implementations, the plurality of close ended questions comprise pairs, trios, and/or larger sets of synonymous, or near synonymous questions, for reducing the risk of mistakes by the model. Other questions may be partially overlapping to existing ones in the question list.

In some implementations, the plurality of close ended questions may access a storage such as the persistent storage 116 or 124 to obtain a plurality of close ended questions, in order to generate a plurality of queries each from a combination of at least one part of the textual content pertaining to users from the group and one of the plurality of close ended questions.

The textual content 230 may be received from an end user device 132, the public cloud 150, the UI device set 126, and/or the like, and it may be a text message, an email, a letter, a blog post, a question, and/or the like.

The textual content may also be entered or received as text, or extracted from a voice recording, a video, and/or the like. The textual content may be in a variety of languages, dialects, jargons, and the likes.

Some implementations of the disclosure, for example those used on languages having lesser representation in available training data, and thus handled less effectively, may apply translation or other pre-processing to evade known weaknesses of the conversational language model.

The textual may be generated by group of users in response to an assignment. As used herein, the term assignment may refer to a class assignment, prompt generated by an online chat-bot, a requirement presented for certification, a question in an online forum, a premade survey, a query sent to a database or a search engine, and other methods to obtain text pertaining to users.

The query generator 240 is used for generating a plurality of queries each from a combination of the textual content and one of the plurality of close ended questions.

For example, when the text is “I would like to spend my next vacation in a seaside resort, not far away from ancient ruins”, some queries to the model may be “Does the text ‘I would like to spend my next vacation in a seaside resort, not far away from ancient ruins’ refer to waterparks”. “Does the text ‘I would like to spend my next vacation in a seaside resort, not far away from ancient ruins’ mention historical sites”, and/or the like.

Some implementation may split the text to several, partially overlapping and/or non-overlapping parts, and generate queries by applying some or all of the plurality of close ended questions on these parts. In some example the option to break textual contents into separate, potentially overlapping text parts such as sentences, paragraphs and/or the like, and ask the closed ended questions on those and then merge the results in the decision module may improve accuracy and robustness, since large language models may have weaknesses. Some implementations may apply parsing based on end of paragraph indications such as newline, a period at a sentence end, a comma, and/or the like. Some implementations of large language models may omit one or more references from the processing of comparatively long documents, and splitting documents to paragraphs, sentences, or parts thereof may reduce the risk of skipping a reference.

For example the textual content may be “Hi everyone, I'm a food enthusiast who is always looking to try new cuisines and experiment with new flavors. Lately, I've been hearing a lot about spices of the orient. I'm particularly interested in two spices that I've heard a lot about—asafoetida and saffron. I've read that asafoetida is a resinous spice that has a strong, pungent aroma and is often used in Indian vegetarian cooking. I'm curious to know what dishes it is commonly used in and what kind of flavor it adds to a dish. Similarly, I've heard a lot about saffron and its use in Persian cuisine. I understand that it is one of the most expensive spices in the world and is known for its distinct, floral aroma and bright orange color. I'm eager to learn more about its flavor profile and what dishes it is commonly used in. As someone who is new to these cuisines, I would love to hear from anyone who has experience cooking with these spices. Are there any recipes that you would recommend for someone who is just starting out? Are there any tips or tricks that I should know before using these spices in my cooking? Thanks in advance for your help! I'm excited to dive into unknown cuisines and can't wait to explore these spices further.”

A question such as “Does the text express interest in oriental cuisines” may find the last paragraph unclear.

Other methods of merging text with questions may be used, such as, combining in an embedding space.

The conversational language model 250 may be an artificial intelligence module designed to generate text based on a given prompt or input. The model may be an incorporated in house or third party machine learning model, which was trained on a large corpus of text and may use deterministic or statistical techniques to generate outputs that are coherent, contextually relevant and semantically meaningful. The language model may be designed to analyze a natural language text and generate responses such as those expected in human conversation. The conversational language may be trained specifically for text evaluation or classification, however models trained for variety of conversational applications, such as chat-bots, virtual assistants, private tutor or psychotherapist emulation and customer service systems may also be used.

Conversational and other generative language models may be powered by advanced machine learning techniques, such as neural networks, and may be fine-tuned to perform specific tasks or to generate outputs in specific domains. Conversational language models may comprise components such as generative transformer network, for example for embedding a word placement in a sentence. Some generative language models comprise one or more autoregressive components, however deterministic methods may also be used.

The models may also be integrated into other systems to provide enhanced capabilities, such as improved natural language processing, text generation, and dialogue management. Followingly, the inferences from the language model may be acquired to form a structure to feed into a decision model to acquire a classification of the textual content.

The analysis model 260 may process the plurality of inference values, each generated by the conversational language model in response to feeding by one of the plurality of queries, and process them to generate at least one evaluation of the textual content.

Some inferences may be binary, for example, showed knowledge or require more training. Other examples may have an inference of multiple possible values such as “basic”, “intermediate”, “advanced”, and “expert”, or “seaside”, “urban” and “mountain”.

For example, a question such as “does the answer show correct understanding of the term epistemic versus ontological”, may lead to inferences such as “Yes”, “Partially”, or “No”.

The at least one evaluation may be based on relevance of the additional textual content to the assignment or checking when a specified suggestion is present in the textual content. For example, if the prompt was directed at refrigerators, explicit reference to refrigerators may lead to “Yes”, A sentence about books to “No”, and mentioning of dairy products or cold streams may be assigned to either, or an inference such as “Maybe”, or “Indirectly”.

Some implementations may be checklist based, for example, “Did the textual content mention France”, “Did the textual content mention Spain”, “Did the textual content mention Portugal”, “Did the textual content mention the Netherlands” and “Did the textual content mention Belgium” In relation to western Europe.

Some implementations may be used to measure how effective an instruction module is. For example, following a chemistry lesson introducing aldehydes the evaluation may be counting how many users in the group of users included the specified suggestion in the textual content pertaining thereto, wherein the specified suggestion may be a double bond of carbon to oxygen. As the suggestion of a double bond of carbon to oxygen is an example of associated item pertaining to an assignment introducing aldehydes.

Some implementations may apply several substantially synonymous questions, for example, asking “Did the textual content mention lemons”, “did the textual content mention citrus fruits”, and “was presence of lemons implied in the textual content” in relation to culinary preference, and a rule such as “when two or more answers are positive, indicate lemons are preferred, otherwise not”.

These are examples of decision models comprises converting the structure to a plurality of logic indications and a rule based model, comprising comparing a weighted or conditioned accumulation of the logic indications to a threshold.

Some other implementations may comprise a classifying machine learning model, i.e. based on an additional machine learning model trained on labelled examples, and/or using other training methods such as active learning to allow less investment in supervision or clustering.

The query prompts 270 may be predetermined, however in some implementations consecutive query prompts may be adapted according to the at least one evaluation of the textual content.

When the textual content is mined from the internet, received from a from filled by a customer, or the like, the at least one second prompt may be used to indicate a result to the operator, content manager, customer success manager, salesmen, mentor, and/or the like.

The at least one second prompt may comprise a suggestion derived from the at least one evaluation, for example, a subject of interest raised in the textual content, or an expected suggestion that was not found in the textual content. An example for the first may be discussing specific cities or islands with a use interested in Greece, and in the second, mentioning metal oxide semiconductor transistors when a user mentioned only bipolar junction transistors.

When the textual content is generated in an interactive process such as computer based tuition or interaction with a chat-bot, the at least one second prompt may also be presented as an additional assignment to the user, student, customer, and/or the like interacting with a system comprising embodiment of the present invention.

The at least one second prompt may asked for elaboration about a product or a service offer a customer may be interested in, repeat an explanation with different phrasing in a tuition session, elaborate on a subject the student showed interest in or seem to understand only partially, and/or the like.

For example, a student may be presented with a prompt “State examples of major cities in the United States western coast” and mentioning in response “Miami, Charleston, and Washington D.C.”. While these are valid examples, the student seems to ignore the New York City, as well as other northern cities. Therefore, exemplary second prompts may be “Do you know New York City?” or “Give examples of major cities in the north part of the United States western coast”.

Referring now to FIG. 3, which is a flowchart of an exemplary process for evaluating a textual content classification, according to some embodiments of the present disclosure. The processing circuitry 120 may execute the exemplary process 300 for a variety of purposes such as examining effectivity of a tuition session, adapting course level, performing computer based training on various subjects, personalizing different tuition methods, adapting tuning recommendation systems, indicate concentration impairments, product customization, and/or the like. Alternatively, the process 300 or parts thereof may be executing using a remote system, an auxiliary system, and/or the like.

The exemplary process 300 starts, as shown in 302, receiving a textual content generated by group of users in response to an assignment.

The textual content, for example 230 may be received by the system through a user interface of the UI device set 126, network module 118, or other data input mechanism. The received text may be stored in volatile memory 112, cache, 122 peripheral storage 124, or the like, to be processed by the system for various applications, such as natural language processing based text classification.

The text may be received during an interaction with a computer based tutorial having an elaborate front end apart from the disclosed process, from a computerized form, an interactive chat-bot session collected from a discussion on the web, and/or the like.

The exemplary process 300 continues, as shown in 304, with processing the textual content to generate a plurality of queries.

The queries may generated by a query generator such as 240, and may combine some or all of the questions from the plurality of close ended questions such as 220 with parts or all of the textual content such as 230. The plurality of queries may be represented in comma separated value files, a list or array of strings, and/or the like, and each query may be in ASCII format, however Unicode, embedding, and other representations may be used. The queries may be a part of larger set adapted to different stages and/or contingencies of an associated front end process, and may comprise subsets having similar meaning.

Some implementations may process the textual content by accessing a storage to obtain a plurality of close ended questions, and generating a plurality of queries each from a combination of at least one part of the textual content pertaining to users from the group and one of the plurality of close ended questions.

For example, regarding a preference of real estate location, queries may be like “how close should the nearest school be”, or “is it important that a park is visible from a bedroom window” at one stage, and “what is the budget” or “What is the acceptable apartment size range”, at another stage.

The exemplary process 300 continues, as shown in 306, with generating a plurality of inference values pertaining to the users, each by feeding one of the plurality of queries to at least one conversational language model.

The conversational language model may be executed by the processor set 110, or remotely on the private cloud 106, or the public cloud 150, and/or the like.

The conversational language model such as 250 may be models such as or based on Generative Pretrained Transformer (GPT), Conditional Transformer Language Model (CTRL), Text-to-Text Transfer Transformer (T5), Recurrent neural networks (RNN), Generative Adversarial Networks (GANs), variational autoencoders, and/or the like, as well as models that are expected to be developed. Some implementations may also comprise a knowledge representation based module, which may be deterministic or stochastic. The conversational language model may generate answers which comprise one of a plurality of answers such as “Yes” and “No”, a number in a range, and/or the like, and these inferences may be fed directly or filtered to a decision model.

The exemplary process 300 continues, as shown in 308, with processing the plurality of inference to generate at least one evaluation of the textual content.

Some evaluation may be binary, for example, “Continue to next subject or “Present the current subject again in a more visual manner”; “Coherent” or “Incoherent” or “lingual correct” or “includes typos”. Other examples may have an inference of multiple possible values such as “Clearly concentrated”, “Probably concentrated”, “Waning concentration”, and “Definitely off”. Other examples, may recommend travel destinations, instruction modules, gadgets, and/or the like.

The decision may be based on comparing a count of positive answers pertaining to a field, for example nature view versus urban attractions, a decision tree, a machine learning model such as a random forest, a support vector machine, a neural network, and/or the like.

The exemplary process 300 continues, as shown in 310, with using the at least one evaluation to generate at least one second prompt.

The second prompt may be indication of the concentration state inferred to a tutor, a request to tailor a vacation, and/or the like. Additionally or alternatively the second prompt may be a question or an assignment directed at the user for consecutive interaction.

And subsequently, as shown in 312, the process 300 may continue by using the at least one second prompt for querying the group of users for an additional textual content. Some implementations may repeat the process 300 with the at least one second prompt as an assignment.

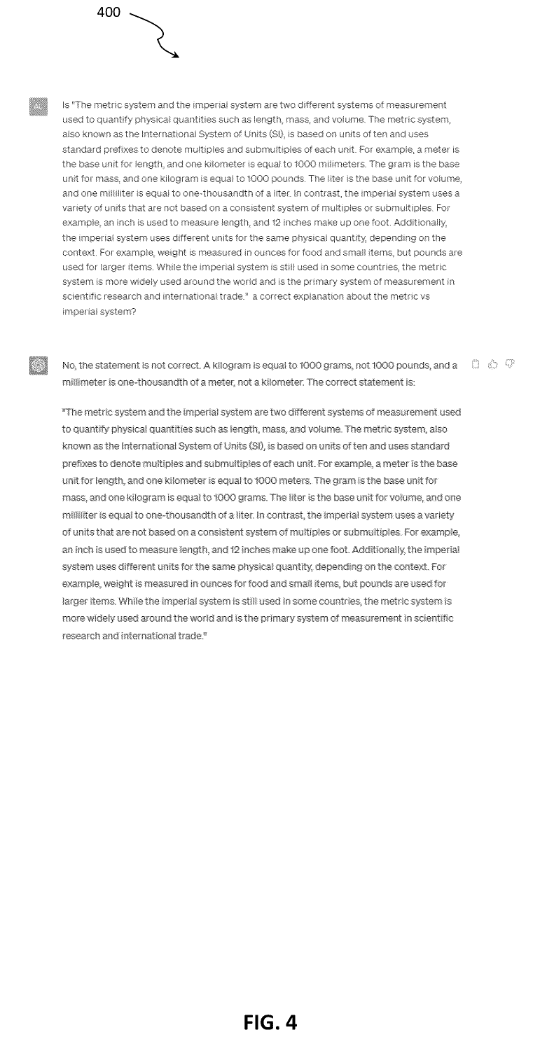

Referring now to FIG. 4, which is an exemplary query on an exemplary textual content, according to some embodiments of the present disclosure.

As shown in 400, some embodiments of the present invention may be used in context of tuition or certification about working with both the metric and imperial measurement unit systems.

The query wrapper may be “Is . . . a correct explanation about the metric vs imperial system”, and may be applied on texts from a student from a group of students. This figure shows one example, where a student made a couple of mistakes which were found by the conversational language model, GPT3. Post processing of the inference may easily find the “No” in the beginning.

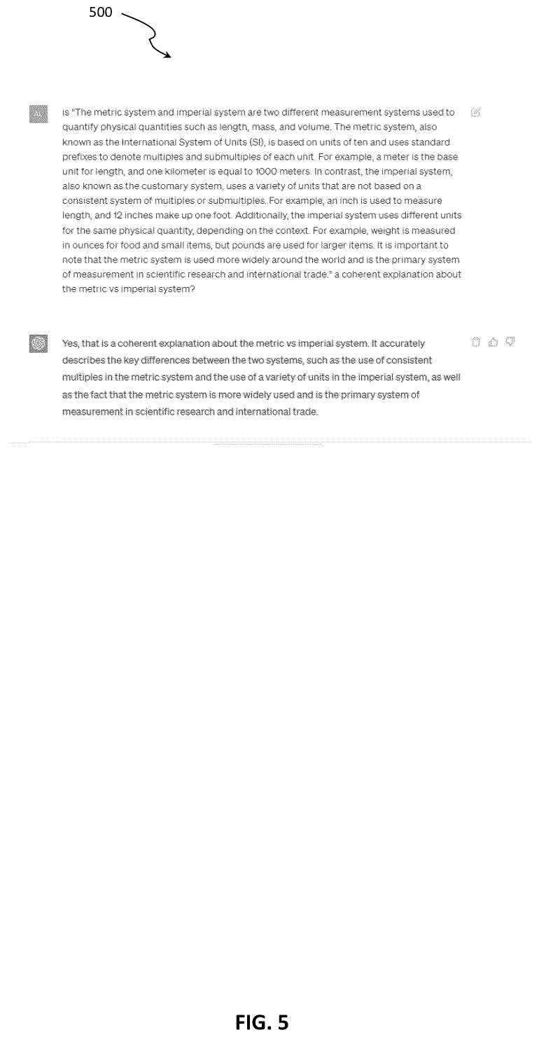

Referring now to FIG. 5 which is an exemplary query on another exemplary textual content, according to some embodiments of the present disclosure.

This figure provides an example in 500 where the student answered correctly. Post processing of the inference may easily find the “Yes”.

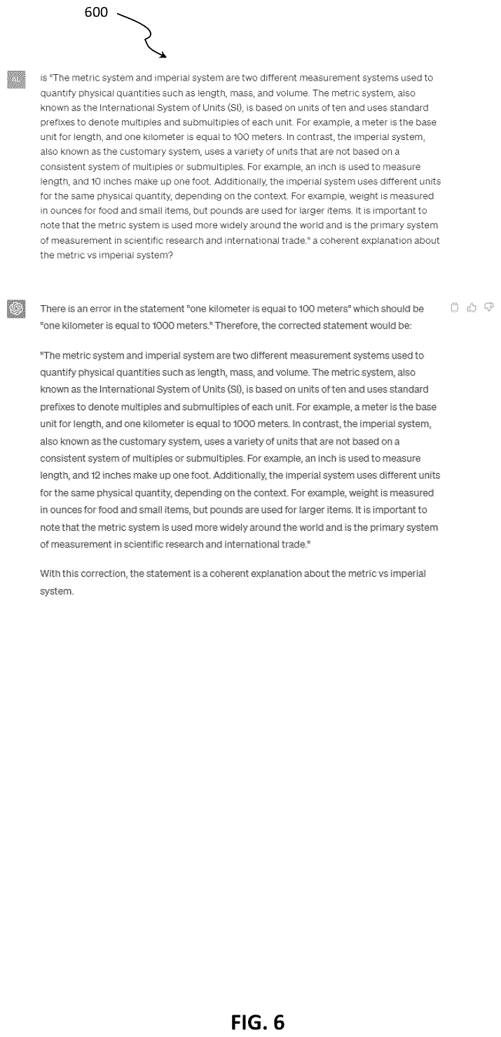

Referring now to FIG. 6 which is another exemplary query on another exemplary textual content, according to some embodiments of the present disclosure.

As shown in 600 the conversational language model, GPT3, found an error.

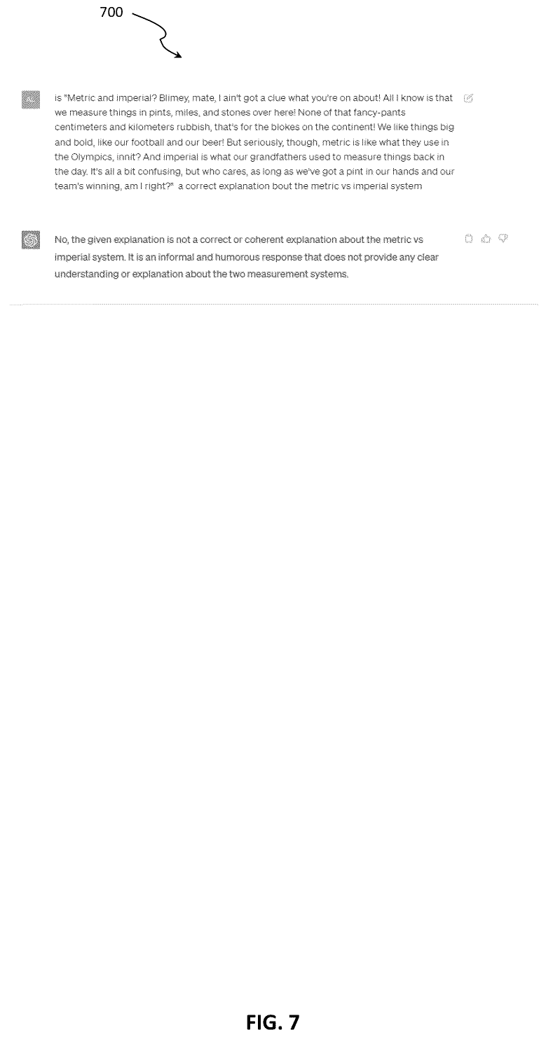

Referring now to FIG. 7 which is another exemplary query on yet another exemplary textual content, according to some embodiments of the present disclosure.

It may be seen in 700 that the text provided by the student does not seem to be coherent and may indicate undesirable influence, mental state, or not taking the lesson seriously. Furthermore, some implementations may comprise evaluation based on evaluating a coherence measure of the textual content, and potentially indicate a problem of suspect for a mental state of substance influence.

Some implementations may comprise detect such conditions, for example, briefing truck drivers before a tasks, to avoid assigning tasks to drivers not at their best.

Some implementations may comprise detection of suggestions not expected in response to the querying of the assignment. For example, if someone mentions football where marine fauna is expected, it may indicate that other vacation destinations may be considered, or that the biology student lost focus.

Some other implementations may use the evaluation to partition a group of students according to a similarity measure. For example, partitioning an audience to an action movie hall, a drama theater, and a sport match. Some of these implementation may offer tailoring classes to groups of students partitioned thereby.

The figures provide example for one question in one subject, however it is apparent to a person skilled in the art that other questions may be asked on the same subjects, about specific aspects of the subject presented, in context of a lesson, an exam, processing reviews, internet forums, queries accumulated from interaction with sales chat-bots, and the like.

It is expected that during the life of a patent maturing from this application many relevant conversational language models, text media, and representation methods will be developed and the scope of the terms conversational language models machine learning model, text, and embedding are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for evaluating understanding in a textual content, comprising:
receiving a textual content generated by group of users in response to an assignment;
processing the textual content to generate a plurality of close ended queries;
generating a plurality of inference values pertaining to the users, each by feeding one of the plurality of close ended queries to at least one conversational language model;
processing the plurality of inference to generate at least one evaluation of the textual content; and
using the at least one evaluation to generate at least one second prompt.

2. The method of claim 1 further comprising using the at least one second prompt for querying the group of users for an additional textual content.

3. The method of claim 2 wherein the at least one evaluation is based on relevance of the additional textual content to the at least one second prompt.

4. The method of claim 2 wherein the at least one second prompt comprising a suggestion derived from the at least one evaluation.

5. The method of claim 1 wherein the at least one evaluation is based on checking when a specified suggestion is present in the textual content.

6. The method of claim 5 wherein the at least one evaluation is counting how many users in the group of users included the specified suggestion in the textual content pertaining thereto.

7. The method of claim 5, wherein the suggestion is associated with an item pertaining to the assignment.

8. The method of claim 1 wherein the at least one evaluation is based on evaluating a coherence measure of the textual content.

9. The method of claim 1 wherein the evaluation comprising detection of suggestions not expected in response to the querying.

10. The method of claim 1 further comprising using the evaluation to partition a group of students according to a similarity measure.

11. The method of claim 1 wherein processing the textual content comprising:
accessing a storage to obtain a plurality of close ended questions; and
generating a plurality of queries each from a combination of at least one part of the textual content pertaining to users from the group and one of the plurality of close ended questions.

12. A system comprising a storage and at least one processing circuitry configured to:
receive a textual content generated by group of users in response to an assignment;
process the textual content to generate a plurality of queries;
generate a plurality of inference values pertaining to the users, each by feeding one of the plurality of close ended queries to at least one conversational language model;
process the plurality of inference to generate at least one evaluation of the textual content; and
use the at least one evaluation to generate at least one second prompt.

13. The system of claim 12 further comprising using the at least one second prompt for querying the group of users for an additional textual content.

14. The system of claim 13 wherein the at least one evaluation is based on relevance of the additional textual content to the at least one second prompt.

15. The system of claim 13 wherein the at least one second prompt comprising a suggestion derived from the at least one evaluation.

16. The system of claim 12 wherein the at least one evaluation is based on checking when a specified suggestion is present in the textual content.

17. The system of claim 16 wherein the at least one evaluation is counting how many users in the group of users included the specified suggestion in the textual content pertaining thereto.

18. The system of claim 16, wherein the suggestion is associated with an item pertaining to the assignment.

19. The system of claim 12 wherein the at least one evaluation is based on evaluating a coherence measure of the textual content.

20. The system of claim 12 wherein the evaluation comprising detection of suggestions not expected in response to the querying.

21. The system of claim 12 further comprising using the evaluation to partition a group of students according to a similarity measure.

22. The system of claim 12 wherein processing the textual content comprising:
accessing a storage to obtain a plurality of close ended questions; and
generating a plurality of queries each from a combination of at least one part of the textual content pertaining to users from the group and one of the plurality of close ended questions.

23. One or more computer program products comprising instructions for evaluating understanding in a textual content, wherein execution of the instructions by one or more processors of a computing system is to cause a computing system to:
receiving a textual content generated by group of users in response to an assignment;
processing the textual content to generate a plurality of queries;
generating a plurality of inference values pertaining to the users, each by feeding one of the plurality of close ended queries to at least one conversational language model;
processing the plurality of inference to generate at least one evaluation of the textual content; and
using the at least one evaluation to generate at least one second prompt.
